(19) United States
(12) Patent Application Publication
(10) Pub. No.: US 2026/0230036 A1
(43) Pub. Date: Aug. 6, 2026

(54) PHOTOVOLTAIC MODULES WITH PANEL-PANEL ELECTRICAL INTERCONNECTS VIA MECHANICAL MOUNTS

(71) Applicant: SAUDI ARABIAN OIL COMPANY, Dhahran (SA)

(72) Inventors: Brian PARROTT, Dhahran (SA); Marwan ABDULLAH, Dhahran (SA)

(73) Assignee: SAUDI ARABIAN OIL COMPANY, Dhahran (SA)

(21) Appl. No.: 19/044,961

(22) Filed: Feb. 4, 2025

(51) Int. Cl. H02S 40/36

(52) U.S. Cl. CPC H02S 40/36

(57) ABSTRACT

A photovoltaic (PV) system includes one or more PV modules, the one or more PV modules including a PV layer having a first side and a second side opposite the first side. The PV modules also include a conductive layer coupled to the second side of the PV layer, the conductive layer further including a positive bus line and a negative bus line extending in a first direction. The conductive layer further includes a vertical bus line extending substantially orthogonally to the first direction and is operable to electrically couple to the positive and negative bus lines. The one or more PV modules can be electrically coupled to other PV modules in series or in parallel.

### FIELD OF THE DISCLOSURE

The present disclosure relates generally to photovoltaic (PV) modules and, more particularly, to mechanically mounting and electrically interconnecting an array of PV modules.

### BACKGROUND OF THE DISCLOSURE

Solar panels, also known as photovoltaic (PV) modules, are devices that convert sunlight directly into electricity through the photovoltaic effect. These panels are composed of multiple solar cells, typically made from silicon, which absorb photons from sunlight and release electrons, generating an electric current. The efficiency of solar panels has significantly improved over the years due to advancements in materials science and engineering, making them a viable and increasingly popular source of renewable energy. Solar panels are used in a variety of applications, from small-scale residential installations to large-scale solar farms that contribute to the electrical grid.

Arrays of solar panels include electrical interconnects that are responsible for linking individual solar cells within a panel and connecting multiple panels together. Design and materials used for these interconnects can impact performance of the solar panel, as well as specific configurations. For example, electrical connections are generally made in a combination of series and parallel configurations to optimize maximum current and voltage that the system is capable of handling. However, conventional solar panel arrays require wires to be attached in specific ways with adjacent solar panels implementing parallel or series connections, which can require special and complex cable connections that complicate deployment of the system.

Furthermore, solar panels are generally mounted to a mounting system (e.g., rack system), and are generally held to the mounting system with clips. For example, some existing systems employ standard slot connections involving a bolt passing through the clip to secure to a nut that is trapped within the slot of the mounting system. Accordingly, mounting solar panels in existing systems is laborious and cumbersome.

### SUMMARY OF THE DISCLOSURE

Various details of the present disclosure are hereinafter summarized to provide a basic understanding. This summary is not an exhaustive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

According to an embodiment consistent with the present disclosure, a photovoltaic (PV) system includes one or more PV modules, the one or more PV modules including a PV layer having a first side and a second side opposite the first side. The one or more PV modules also include a conductive layer coupled to the second side of the PV layer. The conductive layer further includes a positive bus line and a negative bus line, the positive and negative bus lines extending in a first direction. The conductive layer also includes a vertical bus line extending substantially orthogonally to the first direction, wherein the vertical bus line is operable to electrically couple to the positive and negative bus lines.

According to another embodiment consistent with the present disclosure, a photovoltaic (PV) system includes one or more PV modules, the photovoltaic system further including a rack having a first side and a second side opposing the first side. The PV system includes a PV array having two or more PV modules coupled together based on orientation of the two or more PV modules. Each PV module includes a PV layer having a first side and a second side opposite the first side and a conductive layer coupled to the second side of the PV layer. The conductive layer further includes a positive bus line, a carrier bus line, a negative bus line, and a carrier bus line. The positive, carrier, and negative bus lines extend in a first direction. The vertical bus line extends substantially orthogonally to the first direction and is operable to electrically couple to the positive, carrier, and negative bus lines. The PV system also includes one or more bridging connectors operable to selectively electrically couple a given bus line of a first PV module with another bus line of the second PV module depending on a conductive character of a user-selectable fastener.

According to yet another embodiment consistent with the present disclosure, a connector for mechanically and electrically coupling two or more photovoltaic (PV) modules of a PV system, the connector including a first end for receiving a given bus line of a first PV module. The connector includes a second end for receiving another bus line of a second PV module. Further, the connector includes a substrate that is conductive and operable to electrically couple the given bus line to the another bus line. Additionally, the connector includes one or more through holes that extend through the respective connector and the substrate, and are configured to receive a fastener.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIG. 1 is a bottom view of an example photovoltaic module.

FIG. 2 is a bottom view of an example photovoltaic array arranged in parallel.

FIG. 3 is a bottom view of an example photovoltaic array arranged in series.

FIG. 4 is a bottom view of an example photovoltaic array arranged in parallel and configured in series.

FIG. 5 is a bottom view of an example photovoltaic array arranged in series and configured in parallel.

FIG. 6 is a bottom view of an example photovoltaic arrays arranged vertically

FIG. 7 illustrates various views of example connection clips.

FIG. 8 illustrates a side view of an example photovoltaic array interfaced with an example mounting system.

FIG. 9 illustrates a side view of an example photovoltaic array coupled with an example mounting system.

### DETAILED DESCRIPTION

Embodiments of the present disclosure will now be described in detail with reference to the accompanying Figures. Like elements in the various figures may be denoted by like reference numerals for consistency. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying Figures may vary without departing from the scope of the present disclosure.

Embodiments in accordance with the present disclosure generally relate to photovoltaic (PV) modules (e.g., panels) and, more particularly, to mechanically mounting and electrically interconnecting an array of PV modules. Specifically, the PV modules of PV arrays can be directly coupled using panel to panel connections that enable both series and parallel configurations. These connections can be made without cables required in conventional systems. Rather, the PV modules are connected with mechanical hardware that is integrated into electrical connections. That is, the connections can both fix the PV modules together and carry current across the PV modules of an array. Further, the mechanical structure of the PV modules is used to carry the current efficiently through mechanically-reinforcing conductive elements built into the frames of the PV modules to reduce the amount of material needed by using the mechanical elements for the dual purpose of carrying the current as well. Thus, the desired configuration of a PV array can be established based on the orientation of individual PV modules and the connections made between adjacent PV modules. Thus, the PV modules and connectors eliminate the need for cabling and complex deployment required by existing systems. The connectors have clearly defined positions relative to the PV modules compared to wiring configurations of existing systems, such that the PV modules and connectors of the present disclosure may simplify deployment processes performed by robotics and/or users.

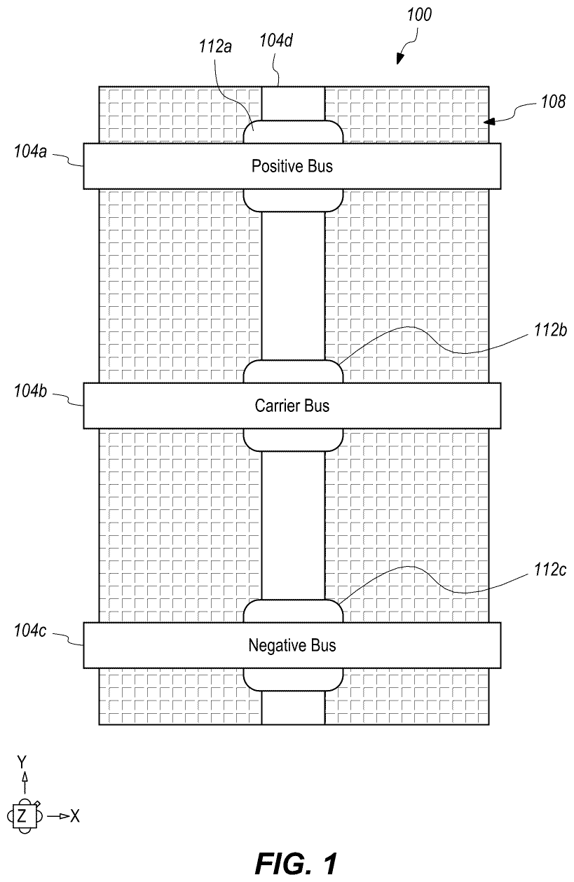

FIG. 1 illustrates a bottom view of an example photovoltaic (PV) module 100. Specifically, the bottom view of the PV module 100 illustrates a conductive layer including bus lines 104 over a PV layer 108. That is, the PV layer 108 can include solar cells that are employed to convert light into electricity, and which are positioned on a side of the PV layer 108 opposite the conductive layer. Light received by the PV layer 108 energizes solar cells within the PV layer 108 creating electron-hole pairs. An electron-hole pair includes an electron free to move across the PV layer 108 leaving a “hole,” the electron-hole pair creating a separation of charges and an electric potential difference across the respective solar cell. Internal electrical fields and connections can be within the PV layer 108 to collect and conduct current generated by electric potential across the PV layer 108.

The PV module 100 may include components to conduct the current generated by the PV layer 108 within a conductive layer. The conductive layer can include bus lines 104 and other electrical and mechanical components. For example, the conductive layer can include a positive bus line 104a, a carrier bus line 104b, and a negative bus line 104c (collectively 104). The positive bus line 104a may be associated with the positive electric potential generated by the PV layer 108, whereas the negative bus line 104c may be associated with the negative electric potential. While the terms “positive” and “negative” are employed herein, the bus lines 104 of respective PV modules 100 are not limited to a specific electric potential. Instead, the “polarity” (e.g.,, positive or negative) of a bus line 104 may refer to the orientation of a respective panel, such that a given bus line 104 is a conductive line for electric potential in various manners discussed herein.

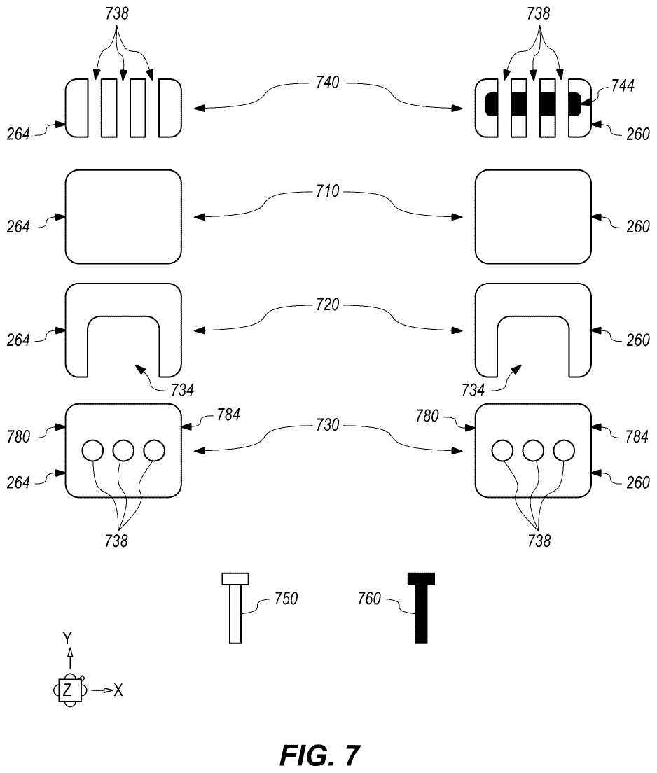

Further, various connections within the PV module 100 can be arranged to define the electric potential across the PV module 100, such as the polarity. The PV module 100 may include various junctions 112 employable to electrically couple or isolate the bus lines 104 of the PV module 100. A vertical bus line 104d can extend vertically (i.e., in the Y direction) across the PV layer 108 and couple to each of the positive bus line 104a, carrier bus line 104b, and negative bus line 104c via the respective junctions 112a, 112b and 112c. That is, the vertical bus line 104d can be substantially orthogonal to the bus lines 104. To electrically couple to or isolate the bus lines 104, the junctions 104 can be coupled to the bus lines 104 with specific connectors (not illustrated in FIG. 1). These connectors enable various intra-panel configurations and are discussed further herein with respect to at least FIGS. 7-9.

In an example, a positive junction 112a can be electrically coupled to a negative junction 112b via a vertical bus line 104d. Thus, the negative bus line 104c can receive power provided to the positive junction 112a. Here, the positive junction 112a may electrically couple the positive bus line 104a to the vertical bus line 104d. Similarly, the negative junction 112c may electrically couple the negative bus line 104b to the vertical bus line 104d. That is, the positive and negative bus lines 104a, 104c are electrically coupled to the vertical bus line 104d. The carrier junction 112b may electrically isolate the carrier bus line 104b from the vertical bus line 104d, but may mechanically couple the carrier bus line 104b to the vertical bus line 104d. In this configuration, the electric potential across the PV module 100 can be measured across the positive bus line 104a and the negative bus line 104c.

The PV module 100 may have different intra-panel configurations that determine polarity and positions of the electric potential within the PV module 100. In a non-limiting example, the positive junction 112a and carrier junction 112b electrically couple the corresponding bus lines 104a, 104b to the vertical bus line 104d. Conversely, the negative bus line 104c is electrically isolated from the vertical bus line 104d. In some examples, the vertical bus line 104d can be electrically coupled to the rest of the bus lines 104a,104b,104c. In other examples, the vertical bus line 104d can be electrically coupled to the rest of the bus lines 104a, 104b,104c. These different intra-panel configuration of the PV module 100 can adjust the characteristics of the PV module 100, as well as how the PV module 100 can be configured with other PV modules in an array of PV modules. Because characteristics of the PV module 100 can be adjusted based intra-panel configurations, a given PV module 100 may be integrated into an array in various manners.

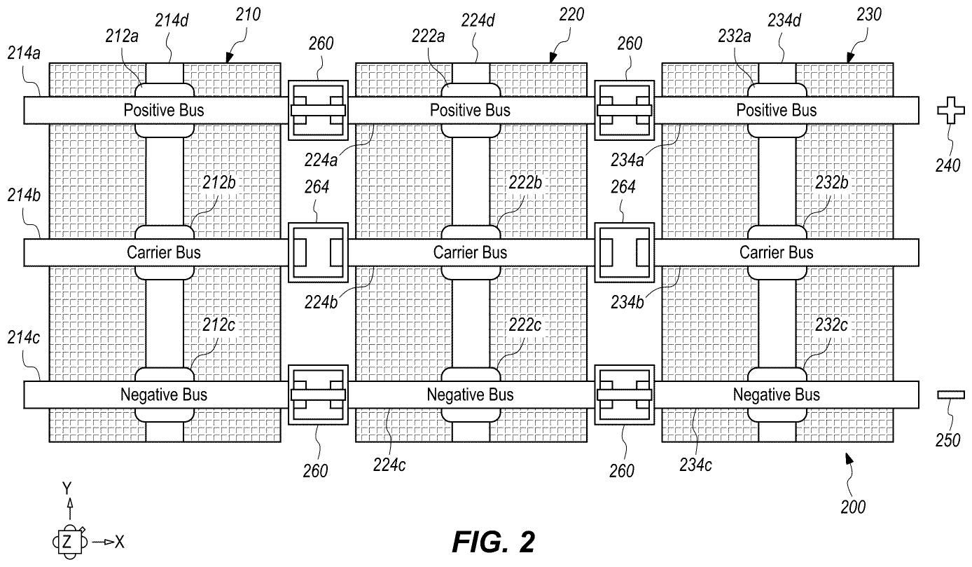

FIG. 2 illustrates a bottom view of an example PV array 200 arranged in parallel (i.e., parallel PV array 200). Specifically, the parallel PV array 200 includes three PV modules 100 electrically coupled in parallel. Here, the PV modules 100 of the parallel PV array 200 are arranged in the same orientation. Specifically, a first PV module 210, a second PV module 220, and a third PV module 230 can have bus lines 214,224, 234 that are collinear. For example, the positive line 214a of the first PV module 210, the positive bus line 224a of the second PV module 220, and the positive bus line 234a of the third PV module 230 are substantially aligned along the same axis, and so on.

As illustrated in FIG. 2, a positive voltage 240 is provided by the positive bus line 234a of the third PV module 230. Specifically, the positive bus line 234a provides the positive voltage 240 at an edge of the third PV module 230 opposite the first and second PV modules 210,220. In other words, the positive voltage 240 is provided at an edge of the parallel PV array 200. Here, a negative voltage 250 can be provided by the negative bus line 234c of the third PV module 230. Accordingly, a circuit can be completed coupling only to the third PV module 230 because the vertical bus line 234d of the third PV module 230 can be coupled together with the corresponding positive bus line 234a and negative bus line 234c. In this example, the carrier bus 234b can be left “open” or unconnected except for the carrier junction 232b that serves to connect the positive and negative bus lines 234a,234c via the vertical bus line 234d. In example PV modules 100 and PV arrays as discussed at least FIGS. 2-6, positive voltage 240 and negative voltage 250 refer to terminals where total electrical potential may be accessed.

The PV modules 210,220,230 of the parallel PV array 200 can be mechanically and electrically coupled together to form the parallel configuration. Accordingly, the positive bus line 234a of the third PV module 230 can be coupled to the positive bus line 224a of the second PV module 220 with a bridging connector 260. A bridging connector 260 electrically couples a given bus line to another bus line. Moreover, a bridging connector 260 can mechanically couple bus lines together to fasten PV modules together. Similarly, the negative bus line 234c of the third PV module 230 can be coupled to the negative bus line 224c of the second PV module 220 via another bridging connector 260.

Furthermore, the carrier bus line 224b of the second PV module 220 can be coupled to the carrier bus line 234b of the third PV module 230 via a non-bridging connector 264. A non-bridging connector 264 can inhibit electrical coupling between bus lines as an insulator, such that no current or power can be exchanged between the carrier bus lines 224b,234b of the second and third PV modules 220,230. In the parallel configuration of the parallel PV array 200, the carrier bus lines 214b, 224b, 234b do not need to carry any current. That is, the second PV module 220 is coupled to the third PV module 230 in parallel. Moreover, the second PV module 220 is coupled to the third PV module 230 in a manner similar to how the third PV module 230 is coupled to the positive voltage 240 and negative voltage.

Additionally, the first PV module 210 can be coupled to the second PV module 220 in parallel. That is, the positive bus lines 214a,224a,234a can be coupled together via bridging connectors 260. Similarly, the negative bus lines 214c,224c,234c can be coupled together via bridging connectors 260. Further, the carrier bus lines 214b,224b,224c can be coupled together via non-bridging connects 264. While the PV modules 210,220,230 of the parallel PV array 200 are coupled together in a parallel configuration, power can be tapped at any location along the positive and negative busses. For example, output power can be tapped at the middle of the parallel PV array 200, such as the positive and negative busses 222a,222c of the second PV module 220. Because the PV modules 100 are coupled in a parallel configuration in the parallel PV array 200, the voltage across each PV module 100 is the same.

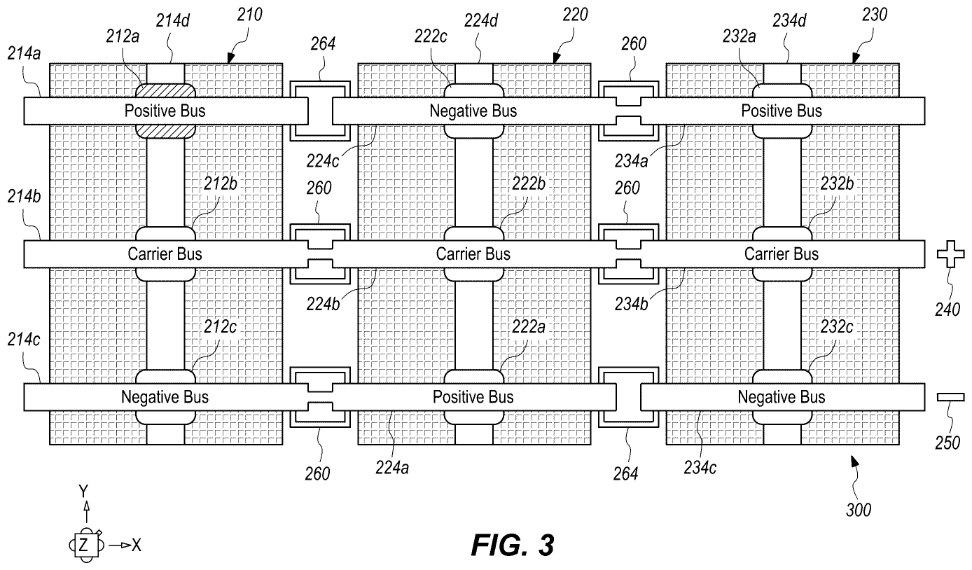

FIG. 3 illustrates a bottom view of another PV array 300 arranged in a series configuration (e.g., series PV array 300). The series PV array 300 can include the PV modules 210,220,230 of the parallel PV array 200 electrically coupled in series. The PV modules 210,220,230 of the series PV array 300 have an inverted orientation compared to the parallel PV array 200. That is, the second PV module 220 is rotated 180° in the series PV array 300 compared to the parallel PV array 200 Accordingly, the negative bus line 224b of the second PV module 220 is collinear with the positive bus lines 214a,234a of the first and third PV modules 210,230. Similarly, the positive bus line 224a of the second PV module 220 is collinear with the negative bus lines 214c,234c of the first and third PV modules 210,230. Thus, alternating the negative and positive bus lines of the PV modules 210,220,230 allows the series PV array 300 to be arranged in series and coupled via the bridging and non-bridging connectors 260,264.

More specifically, the series PV array 300 is arranged in series due to the orientation of the PV modules 210,220,230, as well as the positioning of the bridging and non-bridging connectors 260,264. Particularly, bridging connectors 260 can couple together adjacent and collinear carrier bus lines 214b,224b,234b. Here, a bridging connector 260 can couple together the negative bus line 224c of the second PV module 220 with the positive bus line 234a of the third PV module 230. Further, the positive bus line 224a of the second PV module 220 can be coupled to the negative bus line 214c of the first PV module 210. Additionally, the series PV array 300 can have non-bridging connectors 264. Particularly, the negative bus line 224c of the second PV module 220 can be coupled to the positive bus line 214a of the first PV module 210 via a non-bridging connector 264. Furthermore, the positive bus line 224a of the second PV module 220 can be coupled to the negative bus line 234c of the third PV module 230 via a non-bridging connector 264.

The use of alternating non-bridging connectors 264 made between the negative bus line (e.g., negative bus line 234c) and the positive bus line (e.g., positive bus line 224a) of an adjacent PV module also contributes to the series configuration of the series PV array 300. Furthermore, the carrier bus lines 214b,224b,234b are employed in the series configuration of the series PV array 300, such that the carrier bus lines 214b,224b,234b are used to carry voltage 240 across the PV modules 210,220,230.

In this series configuration, the first PV module 210 has a positive bus line 214a that is electrically coupled to the vertical bus line 214d via the positive junction 212a. The first PV module 210 also has a carrier bus 214b electrically coupled to the vertical bus line 214d, such that the respective positive and carrier bus lines 214a,214b are electrically coupled. While the carrier bus lines 214b,224b,234b are electrically coupled together, the vertical bus lines 224d,234d of the second and third PV modules 220,230 are electrically isolated. Accordingly, positive voltage 240 may be tapped across the three PV modules 210,220,230 via the electrically coupled carrier bus lines 212b,224b,224c. By employing various orientations and connections between PV modules, full power of each of the PV modules 210,220,230 may be carried across the series PV array 300 and have accessibility at either end of the series PV array 300. In another example of this series configuration, the negative voltage 250 can be electrically coupled to the negative bus line 214c of the first PV module 210 and maintaining electrical isolation with the carrier bus lines 214b,224b,234b. In yet another example, the carrier bus lines 212b,224b,234b may electrically couple the negative voltage 250 to the negative bus line 214c of the first PV module 210 in a similar manner.

For example, power can be accessible at the end of bus line, such as a positive voltage 240 at the carrier bus line 234b of the third PV module 230 and a negative voltage 250 at the negative bus line 234c of the third PV module 230. At this location of the series PV array 300, wiring could be connected with either a single integrated connector that comes pre-wired and clips onto the end of the series PV array 300, or smaller connectors that each connect to a single wire for further integration of the power coming from this series PV array 300. Accordingly, the power output of the series PV array 300 can be accessed via locations of the negative and positive voltages 240,250. It should be noted that it is also possible that the tapping point/output point for the power (at least in parallel configurations) is in the middle of the array (e.g., carrier bus junction 222b of the second PV module 220) rather than the end of the array (e.g., the positive and negative voltages 240, 250). Moreover, it is possible to couple a series PV array 300 arranged in series with another series PV array 300 or the parallel PV array 200. Similarly, the parallel PV array 200 can also be coupled to another parallel PV array 200 arranged in parallel. Accordingly, PV arrays 200,300 can be coupled to other PV arrays to extend functionality of a PV system.

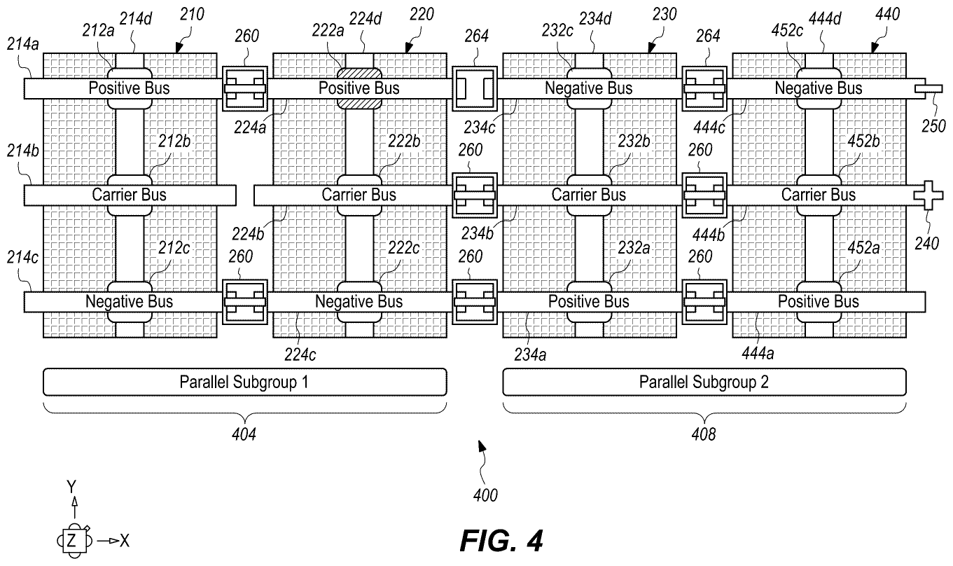

FIG. 4 illustrates a bottom view of another PV array 400 arranged in parallel within a series configuration (e.g., parallel-series PV array 400). Specifically, the PV array 400 includes four PV modules 100 arranged in a first parallel subgroup 404 and a second parallel subgroup 408. The first a parallel subgroup 404 can include the first and second PV modules 210,220. Here, the first and second PV modules 210,220 of the first parallel subgroup 404 can have similar orientations, which are further similar to the orientations of the first and second PV modules 210,220 of the parallel PV array 200 in FIG. 2. Additionally, the first and second PV modules 210,220 can be coupled together in parallel, similar to the parallel PV array 200. The electrical potential across the first PV module 210 can be the same as the second PV module 220 in the parallel-series PV array 400.

The second parallel subgroup 408 is arranged differently than the first parallel subgroup 404, but can still be connected to the first parallel subgroup 404 in series to form the parallel-series PV array 400. The second parallel subgroup 408 includes the third PV module 230, as well as a fourth PV module 440. The third and fourth PV modules 230,440 (e. g,. the second parallel subgroup 408) can be rotated 180° compared to the first and second PV modules 210,220, such that the third and fourth PV modules 230,440 have the same orientation as the second PV module 220 in the series PV array 300. That is, the second parallel subgroup 408 is inverted. Moreover, each of the bus lines 234 of the third PV module 230 can be coupled to the corresponding bus line 444 of the fourth PV module 440 via bridging connectors 260. Further, the positive voltage 240 can be coupled to the parallel-series PV array 400 via the carrier bus line 444b of the fourth PV module 440. Furthermore, the negative voltage 250 can be coupled to the negative bus line 444c of the fourth PV module 440. Accordingly, the third and fourth PV modules 230,440 are coupled in a parallel configuration to form the second parallel subgroup 408.

The parallel-series PV array 400 includes the first parallel subgroup 404 coupled to the second parallel subgroup 408 in series. Specifically, the first parallel subgroup 404 includes the second PV module 220, which is adjacent to the third PV module 230 of the second parallel subgroup 408. Similar to the series PV array 300, the second PV module 220 has an orientation inverse to the adjacent third PV module 230. Accordingly, the second PV module 220 can be coupled to the third PV module 230 in series configuration similar to the first PV module 210 and second PV module 220 of the series PV array 300 of FIG. 3. For example, the positive bus line 224a of the second PV module 220 can be coupled to the negative bus line 234c of the third PV module 230 with a non-bridging connector 264. Further, the carrier bus lines 224b,234b can be coupled together with a bridging connector 260. Furthermore, the negative bus line 224c of the second PV module 220 can be coupled to the positive bus line 234a of the third PV module 230. Thus, the first parallel subgroup 404 is coupled to the second parallel subgroup 408 in series.

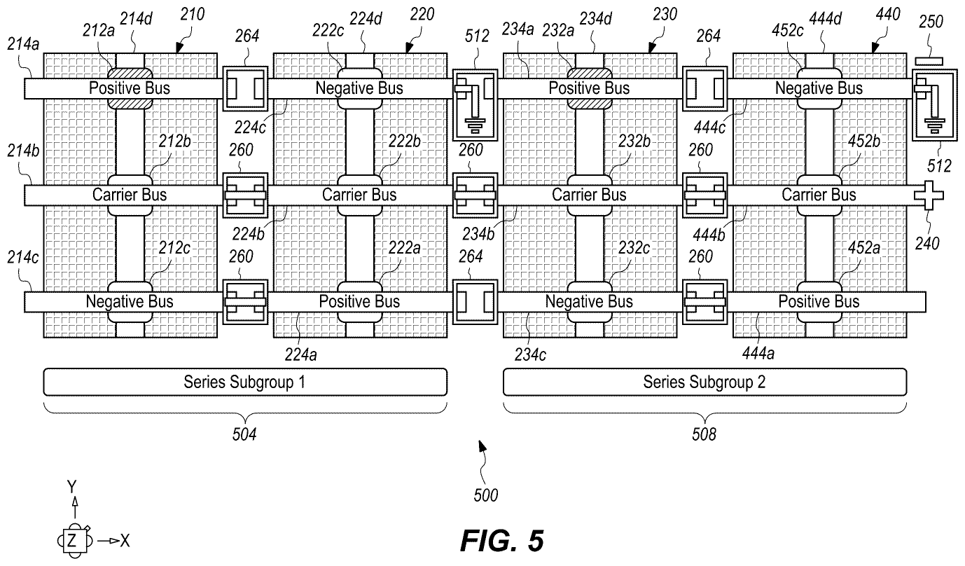

FIG. 5 illustrates a bottom view of a PV array 500 arranged in series within a parallel configuration (e.g., series-parallel PV array 500). That is, the series-parallel PV array 500 can include a first series subgroup 504 having the first PV module 210 and second PV module 220. Further, the series-parallel PV array 500 can also include the third PV module 230 and the fourth PV module 440. Here, each series subgroup is arranged as having one PV module rotated 180° compared to the other PV module of the series subgroup. For example, the first series subgroup 504 includes the second PV module 220 rotated at 180° compared to the first PV module 210 of the first series subgroup 504, such that the second PV module 220 is inverted. Moreover, the first PV module 210 can be coupled to the second PV module 220 in series, such as in the series PV array 300 of FIG. 3. That is, the carrier and negative bus lines 214b,214c can be coupled to the second PV module 220 via bridging connectors 260, whereas the positive bus line 214a is coupled to the second PV module 220 via a non-bridging connector 264. Thus, the first and second PV modules 210,220 are coupled together in series to form the first series subgroup 504. Additionally, the third and fourth PV modules 230,440 are coupled in series in a similar manner to form the second series subgroup 508.

The first and second series subgroups 504,508 can further be coupled together in parallel to form the series-parallel PV array 500. The series-parallel PV array 500 can have positive voltage 240 provided to the carrier bus 444b of the fourth PV module 440, similar to the parallel-series PV array 400. That is, the positive voltage 240 can be carried by the carrier bus lines across the series-parallel PV array 500. Here, each series subgroup 504,508 includes a positive bus line and junction furthest from the positive voltage 240. The series-parallel PV array 500 is configured to electrically couple the positive bus line 232a of the third PV module 230 with the positive voltage 240. Similarly, the positive bus line 214a of the first PV module 210 is electrically coupled to the positive voltage 240. Accordingly, the series subgroups 508,510 are arranged in series similar to the series PV array of FIG. 3.

The negative voltage 250 can be provided to the negative bus line 444c of the fourth PV module 440. To couple the first and second series subgroups 504,508 in parallel, the series-parallel PV array 500 can further include grounding connectors 512. Specifically, the grounding connectors 512 provide common grounding points to interconnect the negative terminals (e. g, negative bus lines 224c,444c) of the series-parallel PV array 500. Alternatively, another bus could be provided to each of the PV modules to enable interconnection of the negative potential. This bus for enabling interconnection of the negative potential could alternatively be integrated into an existing bus line (e.g., the carrier bus line) as a separate conductive element.

The negative voltage 250 can also correspond to a grounding connector 512. Similarly, the negative bus line 224c of the second PV module 220 can be coupled to a grounding connector 512, rather than to the positive bus line 234a of the third PV module. To connect the first series subgroup 504 to the second series subgroup 508 in parallel, the positive bus line 224a of the second PV module 220 can be coupled to the negative bus line 234c of the third PV module 230 via a non-bridging connector 264. Furthermore the carrier bus lines 224b,234b of the first and second PV modules 220,230 can be coupled with a bridging connector 260. Thus, the electrical potential across the first series subgroup 504 can be the same as the second series subgroup 508, such that the first series subgroup 504 is parallel to the second series subgroup.

Different configuration of PV modules and subgroups can be arranged to meet desired electrical needs. That is, a PV system is not limited to series-parallel PV arrays 500, parallel-series PV arrays, parallel PV arrays 200, or series PV arrays 300. Varying arrangements can be made and a series PV array 300 can be coupled to another series PV array 300. Similarly, a parallel PV array 200 can be coupled to another parallel PV array 200. Moreover, differing subgroups (e.g., a first parallel subgroup 404 and a first series subgroup 508) can be coupled together in series or parallel. To change the configuration (e.g., series or parallel) of a group of PV modules, individual PV modules can be rotated and differing connectors (e.g., bridging connector 260, non-bridging connector 264, grounding connector 512) can be employed to meet the desired electrical performance of the PV system. Moreover, each of the PV arrays 200,300,400,500 are illustrated as having PV modules aligned horizontally, such that each bus line can be coupled with collinear bus line of an adjacent PV module. However, PV modules can also be coupled together vertically.

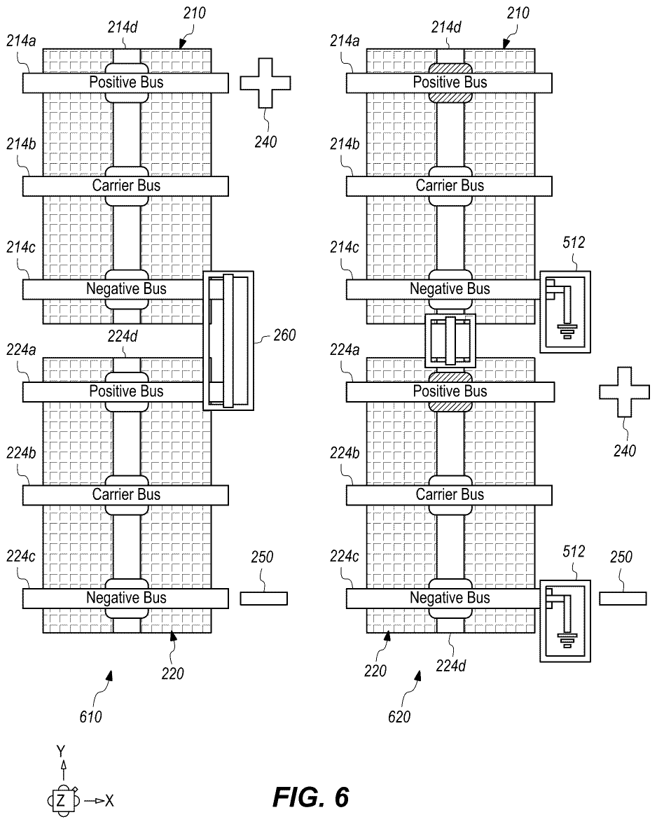

FIG. 6 illustrates a bottom view of example PV arrays including PV modules coupled together vertically. For example, a vertical series PV array 610 is illustrated as having the first PV module 210 and the second PV module 220. Here, the first PV module 210 has the same orientation as the second PV module (e.g., rotation of 0°). However, the first PV module 210 is positioned above the second PV module 220, such that the negative bus line 214c of the first PV module 210 is adjacent to the positive bus line 224a of the second PV module 220. Moreover, in the vertical arrangement between the first and second PV modules 210,220, the negative bus line 214c is parallel to the positive bus line 224a, rather than collinear as illustrated in the series PV array 300 of FIG. 3.

To deploy a vertical series PV array 610, the positive voltage 240 can be applied to the positive bus line 214a of the first PV module 210. Additionally, the negative voltage 250 can be applied to the negative bus line 224c of the second PV module 220. To complete the circuit of the vertical series PV array 610, a bridging connector 260 can connect the negative bus line 214c of the first PV module 210 to the positive bus line 224a of the second PV module 220. That is, the voltage can travel from a give positive bus line 104a to a negative bus line 104c via a vertical bus line (e.g., vertical bus line 104d) and vice-versa.

In another example, a vertical parallel PV array 620 can include the first and second PV modules 210,220 with a similar vertical orientation as the vertical series PV array 210. The vertical parallel PV array 620 can couple the first and second PV modules in parallel by employing grounding connectors 512 at each of the negative bus lines 214c,224c. Moreover, the positive voltage 240 can be applied to the positive bus line 214a of the first PV module 210 and the negative voltage 250 can be applied to the negative bus line 224c of the second PV module 220. Accordingly, the negative bus lines 214c,224c are both coupled to ground via the grounding connectors 512, such that the first and second PV modules 210,220 are arranged in parallel. Moreover, the positive bus lines 214a,224a can be coupled via the vertical bus lines 214d,224d, which are further coupled by a bridging connector 260. Therefore, each of the positive bus lines 214a,214b are electrically coupled to the respective vertical bus lines 214d,224d in the vertical PV array 620. In this configuration, the positive voltage 240 is expressed uniformly at each positive bus lines 214d,224d, as well as the vertical bus lines 214d,224d. Here, the negative voltage 250 is applied at the negative bus lines 214c,224c via grounding connectors 512 in parallel with the positive voltage 240.

FIG. 7 illustrates example views of connectors for coupling bus lines 104 of adjacent PV modules 100. Specifically, FIG. 7 illustrates a bridging connector 260 and a non-bridging connector. As illustrated, the bridging connector 260 has a similar structure to the non-bridging connector 264 from a front view 710, a side view 720, and a bottom view 730. From a front view 710, both the bridging connector 260 and non-bridging connector 264 have substantially rectangular shapes. From a side view 720, both the bridging connector 260 and non-bridging connector 264 have a rectangular shape, as well as a recess 734. The respective recesses 734 can be configured to receive bus lines of adjacent PV modules 100. In some examples, the bus lines of adjacent PV modules 100 can be housed in mechanical carriers, such that recesses 734 are configured to enclose the mechanical carrier. The connectors 260,264 may therefore fit over such mechanical carriers or bus lines to provide a mechanical and electrical connection between the bus lines. Additionally, the bridging connector 260 and non-bridging connector 264 may have similar rectangular shapes from the bottom view 730. The connectors 260,264 are illustrated as having rectangular shapes in a non-limiting example. That is, the connectors 260,264 can have different shapes. In other non-limiting examples, the connectors 260,264 can have features such as press fit or spring steel clips for securing bus lines or mechanical carriers. Furthermore, the

Moreover, the bridging connector 260 and non-bridging connector 264 each have a set of through holes 738 that extend through the respective connectors. In the illustrated example, each connector 260,264 has three holes 738. The holes are configured to receive a bolt, pin, or other fastening device that can secure together adjacent bus lines 104 of PV modules 100. FIG. 7 further includes a cross-sectional view 740 of the bridging and non-bridging connectors 260,264. When viewed from the cross-sectional view 740, the through holes 738 extend through the body of the respective connectors 260,264. In each view of the non-bridging connector 264, the non-bridging connector 264 is illustrated in gray representing a non-conductive material. That is, the body of the non-bridging connector 264 is does not include a conductor to conduct current, such that the non-bridging connector 264 can block current between coupled bus lines 104. Conversely, the bridging connector 260 includes a conductive substrate 744 illustrated as black within the center of the body of the bridging connector 264. Accordingly, the bridging connector 260 can conduct current, such that the bridging connector 260 can pass current between coupled bus lines 104. The main difference between the non-bridging connector 264 and the bridging connector 260 is the presence of the conductive substrate 744, which is present in the bridging connector 260 but lacking in the non-bridging connector 264.

Moreover, the bridging connector 260, as well as the non-bridging connector 264, can be installed with various fasteners that impact conductivity between PV modules 100. For example, a non-conducting fastener 750 can be provided to the one or more of the through holes 738 of the bridging connector 260. The non-conducting fastener 750 can be formed from material similar to the body of the connectors 260,264, such that the non-conducting fastener 750 is an insulator. Accordingly, the non-conducting fastener placed within a through hole 738 of a bridging connector 738 can disrupt the conductive substrate 744, which is penetrated by at least one through hole 738 as illustrated in the cross-sectional view 740. Alternatively, a conducting fastener 760 can be provided to the bridging connector 260 to extend the conductive substrate 744 across the body of the bridging connector 260. Specifically, the body of the conducting fastener 760 can formed from the insulating material, similar to the non-conducting fastener 750. However, the conducting fastener 760 can be coated with a conductive material similar to the material of the conductive substrate 744 of the bridging connector 260. In another example, a fastener can include an insulating portion and a conducting portion. Thus, variability of connectors 260,264 and the fasteners 750,760 employed to fasten the connectors 260,264 allows for increased flexibility with implementing PV modules 100 to meet desired goals.

In an example, the desired goals can specific electrical and mechanical arrangements between PV modules 100, which may be effectuated by the presence of the through holes 738. Each connector 260,264 can have a first end 780 and a second end 784, which is better illustrated with respect to the through holes 738. That is, the side view 720 depicting recesses 734 can be illustrative of both the first end 780 and second end 784 of given connector 260,264. With the three through holes 738 in a given bridging connector 260, conducting fasteners 760 can be added to the outer through holes 738, which are through holes most proximal to the first and second ends 780,784. Adding conducting fasteners 760 to a through hole 738 proximal to either the first end 780 or second end 784 can electrically couple a bus line to the substrate 744. To electrically couple adjacent PV modules 100, a conducting fastener 760 can be added to both of the outermost through holes 738.

Moreover, adding a conductive fastener 760 to a middle through hole 738 may ground the conductive substrate 744 to a rack or frame of the PV system. Thus, this ground to the rack or frame could be the common ground represented by grounding connectors 512 of FIGS. 5-6. For example, the negative bus line 224c of the second PV module 220 can be coupled to the positive bus line 234a of the third PV module 230 with a bridging connector in FIG. 5. That is, the grounding connector 512 may be a bridging connector 260 that employs conducting fasteners 760 at a middle through hole 738 and a through hole 738 proximal to the negative bus line 224c. The bridging connector 260 employed as a grounding connector 512 can mechanically couple and electrically isolate the positive bus line 234a of the third PV module 230. Electrical isolation can be achieved by a non-conductive fastener 750 at the through hole 738 proximal to the positive bus line 234a. Another desired goal can be to couple together adjacent bus lines, such that conducting fasteners 760 are provided to the outer through holes 738, whereas a non-conducting fastener 750 is provided to the middle through hole 738. This configuration does not provide a common ground, but electrically couples the adjacent bus lines via the conductive substrate 744.

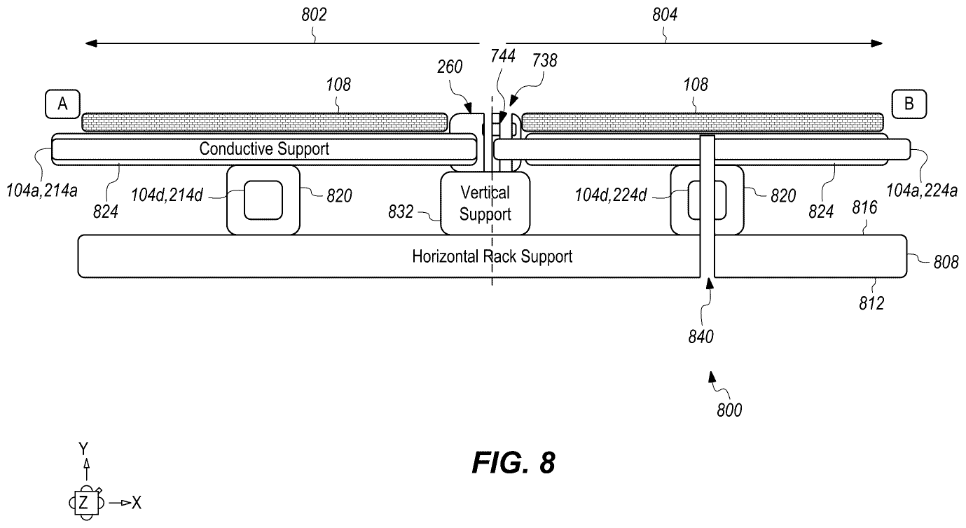

FIG. 8 illustrates a first view 802 and a second view 804 of a PV mounting system 800, the front view 802 extending in the negative X direction and the cross-sectional view 804 extending in the positive X direction. The first and second views 802,804 of the PV mounting system 800 are cross-sectional views of the PV mounting system 800. The first view 802 illustrates a cross-section of the PV mounting system 800 deep enough (e.g., Z direction) to illustrate layers of a junction 104d. The second view 804 is a cross-section of the PV mounting system 800 that is deeper (e.g., further in the Z direction) than the first view, and is deep enough to illustrate through holes 738 of the bridging connector 260.

The PV mounting system 800 includes two or more PV modules 100. Here, the two PV modules 100 of the PV mounting system 800 can be the first and second PV modules 210,220. The PV mounting system 800 also includes a horizontal rack 808. The horizontal rack 808 can be a rigid support structure for supporting a PV module 100, array (e.g., PV arrays 200,300,400,500), or system. The horizontal rack 808 can have a first side 812 that is configured to secure to a structure such as a wall, roof, the ground, or another structure capable of positioning the PV modules 100. The horizontal rack 808 also has a second side 816 opposite the first side 812 that is configured to interface with one or more PV modules 100. Specifically, the second side of horizontal rack 808 can contact a surface of a main body 820 of a PV module 100. The main body 820 can be a conduit that houses the vertical bus line 104d of the respective PV module 100. The PV module 100 can also include a bus body 824, which is perpendicular to the main body 820, such that the bus body 824 is substantially orthogonal to the main body 820. That is, the positive, carrier, and negative bus lines 140a, 140b, 140c run perpendicular to the vertical bus line 140d and are carried in respective perpendicular bus bodies 824. Specifically, bus body 824 is a conduit that houses a bus line 104. The main body 820 and bus bodies 824 can be formed from an insulative material, such that the main body 820 and bus bodies 824 are non-conductive, as illustrated with a solid color. Moreover, the bus bodies 824 can be integrated with the surface of the main body 820 opposite the horizontal rack 808.

As discussed herein, bus lines of 104 of adjacent PV modules 100 can be coupled together to mechanically secure and/or electrically couple PV modules 100 together. Specifically, a bridging connector 260 can connect to the bus lines 104 of the respective PV modules 100. The bridging connector 260, or alternatively a non-bridging connector 264, can couple to the bus lines 104 and interface with a vertical support 832. The vertical support 832 an be positioned on the second side 816 of the horizontal rack 808 to provide support to connectors 260,264 in addition to the main bodies 820 of the adjacent PV modules 100. In the front view 802, which extends to the left of the center 836 of the bridging connector 260, the bridging connector 260 resembles the front view 710 of a bridging connector 260 as shown in FIG. 7. To the right of the center 836, the cross-sectional view 804 of the bridging connector 260 resembles the cross-sectional view 740 of the bridging connector 260 as shown in FIG. 7. In the cross-sectional view 804 of FIG. 8, a bus line 104 of each of the PV modules can extend into the bridging connector 260. In this example, the positive bus lines 214a,224b of the first and second PV modules 210,220 extend into the bridging connector 260.

Moreover, the cross-sectional view 804 of FIG. 8 also illustrates the cross section of the horizontal rack 808, the main body 820, the bus body 824, and the positive bus line 224a of the second PV module 220 share a common hole 840. A common hole 840 is similar to the through holes 738 of the connectors 260,264, as the common hole 840 extends through a given component (e.g., the horizontal rack 808) and is configured to receive a fastener (e.g., a conducting fastener 760). Moreover, the common hole 840 extends through multiple components including the horizontal rack 808, the main body 820, the bus body 824, and the positive bus line 104a. Accordingly, various electrical configurations of the PV module 104 can be implemented with a given conducting fastener 760 provided to the common hole 840.

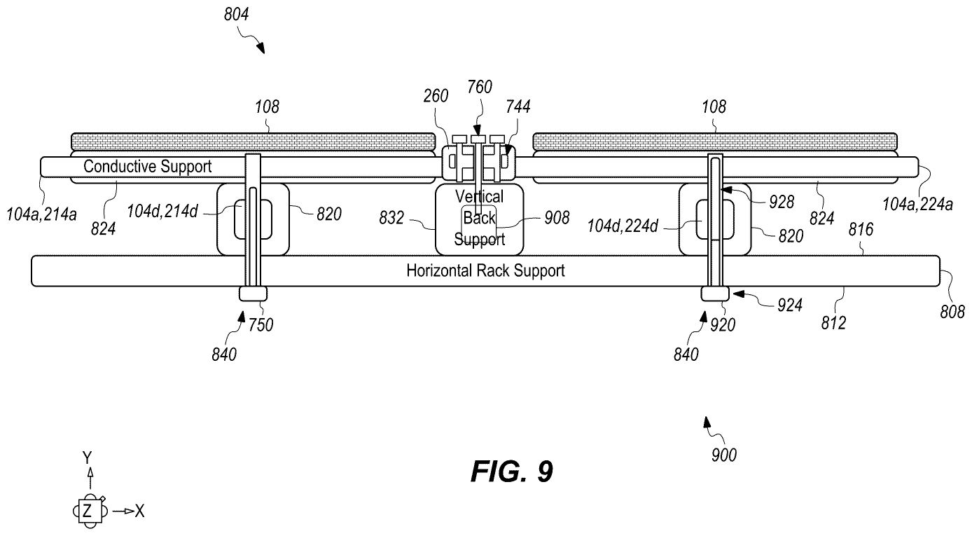

FIG. 9 illustrates a cross-sectional view 804 of an assembled PV mounting system 800. As discussed, the orientation of the PV modules 210,220, as well as the connector 260,264 employed to connect the PV modules 210,220, impacts the functionality of the resultant PV array. For example, the PV modules 210,220 can be arranged in parallel to form the parallel PV array 200, such that the positive bus lines 214a,224a are electrically and mechanically coupled together via the bridging connector 260. To mechanically and electrically couple the bus lines 214,224, the bridging connector 260 can receive conducting fasteners 760. Accordingly, the conducting fasteners 760 can allow current to pass from the positive bus line 214a of the first PV module 210 to the positive bus line 224a of the second PV module 220 through the conductive substrate 744 and conducting fasteners 760. Specifically, the conducting fasteners 760 electrically interconnect the positive bus lines 104a by providing empty space within the bridging connector 260 created by the through holes 738 with conductive material. Furthermore, the conducting fasteners 760 can be employed to further fasten the bridging connector 260 to the vertical support 832 to thereby mechanically couple the PV modules 100 together and to the horizontal rack 808.

Furthermore, the vertical support 832 can also house an earth ground 908, which may be conductive element. The earth ground 908 can extend along the length of the vertical support 832 and provide a common ground to the PV modules 100. Accordingly, the conducting fasteners 760 can include a first conducting fastener 760a, a second conducting fastener 760b, and a third conducting fastener 760c. The second conducting fastener 760b can extend through the vertical support 832 to contact the earth ground 908, such that the bus lines 214,224 are coupled to a common ground. In another embodiment, a non-conducting fastener 750 can be employed in place of the third conducting fastener 760c. Therefore, the positive bus line 224a of the second PV module 220 would be electrically disconnected from the earth ground 908 and the positive bus line 214a of the first PV module 210. However, the positive bus line 214a of the first PV module 210 would still be electrically coupled to the earth ground 908 via the bridging connector 260, and first and second conducting fasteners 760a,b. Accordingly, various fasteners can be employed to adjust configurations of PV modules 100. That is, bridging connectors 260 can be used at each connection point between PV modules 100, but electrical conductivity can be eliminated by using non-conducting fasteners 750. Thus, a bridging connector 260 can be implemented as a non-bridging connector 264 by using the non-conducting fasteners 750.

Furthermore, the cross-sectional view 804 further illustrates a first common hole 840a that extends from the horizontal rack 808 to the positive bus line 214a of the first PV module 210. Similarly, a second common hole 840b extends from the horizontal rack 808 to the positive bus line 224a of the second PV module 220. Accordingly, the vertical bus lines 214d,224d can be coupled to the respective positive bus lines 214a,224a via the respective common holes 840. For example, a partially conductive fastener 920 can be employed to couple the vertical bus line 224d of the second PV module 220 to the positive bus line 224a of the second PV module 220. Specifically, a partially conductive fastener 920 can be coated partially with conductive material, such that a head end 924 of the partially conductive fastener 920 is non-conductive and the threaded end 928 of the partially conductive fastener 920 is conductive. Thus, the head end 924 can serve as an insulator that protects the electrical system of the PV modules 100 by eliminating risk of short circuits, electric shock or fires due to an exposed conductor at the horizontal rack 808. However, the threaded end 928 is conductive, such that the threaded end can electrically couple the vertical bus line 224d and the positive bus line 224a of the second PV module 220. Thus, the coupling of the vertical bus line 224d and positive bus line 224a can establish the positive junction 222a of the second PV module 220.

In another example, a non-conducting fastener 750 can be provided to the first common hole 840a. Accordingly, the non-conducting fastener 750 does not electrically couple the vertical bus line 214d with the positive bus line 214a of the first PV module 210. Furthermore, the non-conducting fastener 750 does not have to extend the entire length of the first common hole 840a, as the non-conducting fastener 750 does not need to electrically couple to the positive bus line 214a. Rather, the non-conducting fastener 750 is employed to mechanically fasten the first PV module 210 to the horizontal rack 808 via the main body 820a housing the vertical bus line 214d.

Embodiments disclosed herein include:
A. photovoltaic (PV) system comprising one or more PV modules, the one or more PV modules comprising: a PV layer having a first side and a second side opposite the first side; and a conductive layer coupled to the second side of the PV layer, the conductive layer further comprising: a positive bus line; a negative bus line, wherein the positive and negative bus lines extend in a first direction; and a vertical bus line extending substantially orthogonally to the first direction, wherein the vertical bus line is operable to electrically couple to the positive and negative bus lines.
B. A photovoltaic (PV) system comprising one or more PV modules, the photovoltaic system further comprising: a rack having a first side and a second side opposing the first side; a PV array having two or more PV modules coupled together based on orientation of the two or more PV modules, each PV module comprising: a PV layer having a first side and a second side opposite the first side; and a conductive layer coupled to the second side of the PV layer, the conductive layer further comprising: a positive bus line; a carrier bus line; a negative bus line, wherein the positive, carrier, and negative bus lines extend in a first direction; and a vertical bus line that extends substantially orthogonally to the first direction, wherein the vertical bus line operable to electrically couple to the positive, carrier, and negative bus lines; one or more bridging connectors operable to selectively electrically couple a given bus line of a first PV module with another bus line of the second PV module depending on a conductive character of a user-selectable fastener.
C. A connector for mechanically and electrically coupling two or more photovoltaic (PV) modules of a PV system, the connector comprising a first end for receiving a given bus line of a first PV module; a second end for receiving another bus line of a second PV module; a substrate that is conductive and operable to electrically couple the given bus line to the another bus line; one or more through holes that extend through the respective connector and the substrate, and are configured to receive a fastener.

Each of embodiments A through C may have one or more of the following additional elements in any combination: Element 1: a first and second PV module coupled together via one or more bus lines. Element 2: wherein the first and second PV modules are coupled in an electrically parallel connection, with the first and second PV modules having uniform orientation, the negative bus line of the first PV module coupled to the negative bus line of the second PV module, and the positive bus line of the first PV module coupled to the negative bus line of the second PV module. Element 3: a third PV module coupled to the second PV module in an electrically parallel configuration. Element 4: each PV module further comprising a carrier bus line operable to electrically couple to the respective vertical bus line, wherein the PV modules are adjacent to each other and are arranged horizontally, with at least the carrier bus line of each PV module being collinear with the carrier bus lines of the adjacent PV modules.
Element 5: wherein the first and second PV module form a first electrically parallel subgroup, the PV system further comprising a second electrically parallel subgroup coupled to the first parallel subgroup having a third and fourth PV module inverted with respect to the first electrically parallel subgroup, and each of the bus lines of the third PV module are coupled to the corresponding bus line of the fourth PV module. Element 6: wherein the first electrically parallel subgroup is coupled to the second electrically parallel subgroup in series, such that the carrier bus line of the third PV module is coupled to the carrier bus line of the second PV module, the positive bus line of the third PV module is coupled to the negative bus line of the second PV module, and the positive and carrier bus lines of the second PV module are electrically coupled via the vertical bus line of the second PV module.
Element 7: each PV module further comprising a carrier bus line operable to electrically couple to the respective vertical bus line, wherein the first and second PV modules are inverted with respect to each other and coupled in an electrically series configuration, such that the negative bus line of the first PV module is coupled to the positive bus line of the second PV module and the carrier bus line of the first PV module is coupled to the carrier bus line of the second PV module. Element 8: wherein a third PV module is coupled to the second PV module in series and the positive and carrier bus lines of the first PV module are electrically coupled via the vertical bus line of the first PV module, such that the first, second, and third PV modules are coupled together in series. Element 9: wherein the first and second PV module form a first series subgroup, the PV system furthering comprising a second series subgroup electrically coupled to the first series subgroup and includes a third and fourth PV module oriented and electrically together in a manner similar to the first series subgroup.
Element 10: wherein the second series subgroup is coupled to the first series subgroup in an electrically parallel configuration, such that the carrier bus line of the second PV module coupled to the carrier bus of the third PV module, a grounding connector is coupled to the negative bus lines of the second and fourth PV modules, and the vertical bus line electrically couples the positive and carrier bus lines each of the first and third PV modules. Element 11: wherein the first and second PV modules are arranged vertically, such that the vertical bus lines of the first and second PV modules collinear, and the first and second PV modules are electrically coupled in series such that the negative bus line of the first PV module is electrically coupled to the positive bus line of the second PV module. Element 12: wherein the first and second PV modules are arranged vertically, such that the vertical bus lines of the first and second PV modules are collinear, and the first and second PV modules are electrically coupled in parallel such that the negative bus lines of the first and second PV modules are electrically coupled to grounding connectors, the vertical and positive bus lines of the first and second PV modules are electrically coupled together.
Element 13: wherein the rack further comprises a vertical support housing a conductive element to provide a common ground, and the one or more bridging connectors are operable to mechanically and electrically couple the given bus line and the another bus line to the common ground. Element 14: the one or more bridging connectors further comprising a conductive substrate for carrying current between the given bus line and the another bus line; one or more through holes that penetrate the conductive substrate; one or more fasteners corresponding to the one or more through holes to mechanically fasten the respective bridging connector to the vertical support of the rack, wherein the one or more fasteners provide a conducting surface to electrically couple with the conductive substrate and electrically couple the given bus line to the other bus line and/or the common ground. Element 15: wherein one or more of the fasteners provides an insulating surface to one or more of the corresponding through holes to electrically decouple the given bus line from the common ground and/or the another bus line, with the first and second PV modules coupled in series or parallel based on orientation of the modules and surfaces provided by the one or more fasteners.
Element 16: wherein the one or more through holes receives a fastener for mechanically coupling the two or more PV modules, the fastener selectively providing a conductive surface to the one or more through holes to electrically couple the substrate and one of the given bus line or the another bus line. Element 17: wherein the one or more through holes are a first through hole and the fastener is a first fastener that electrically couples the substrate and the given bus line, the connector further comprising a second through hole configured to receive a second fastener having a conductive surface for electrically coupling the substrate to a common ground via a conductive element of the PV system.

By way of non-limiting example, exemplary combinations applicable to A through C include: Element 1 with Element 2; Element 2 with Element 3; Element 2 with Element 4; Element 4 with Element 5; Element 5 with Element 6; Element 1 with Element 7; Element 7 with Element 8; Element 7 with Element 9; Element 9 with Element 10; and Element 1 with Element 11; Element 1 with Element 12; Element 13 with Element 14; Element 14 with Element 15; Element 16 with Element 17.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation used herein are merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, if used herein, the terms “coupled” or “coupled to” or “connected” or “connected to” or “attached” or “attached to” may indicate establishing either a direct or indirect connection, and is not limited to either unless expressly referenced as such.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

The invention claimed is:

1. A photovoltaic (PV) system comprising one or more PV modules, the one or more PV modules comprising:
a PV layer having a first side and a second side opposite the first side; and
a conductive layer coupled to the second side of the PV layer, the conductive layer further comprising:
a positive bus line;
a negative bus line, wherein the positive and negative bus lines extend in a first direction; and
a vertical bus line extending substantially orthogonally to the first direction, wherein the vertical bus line is operable to electrically couple to the positive and negative bus lines.

2. The PV system of claim 1, further comprising a first and second PV module coupled together via one or more bus lines.

3. The PV system of claim 2, wherein the first and second PV modules are coupled in an electrically parallel connection, with the first and second PV modules having uniform orientation, the negative bus line of the first PV module coupled to the negative bus line of the second PV module, and the positive bus line of the first PV module coupled to the negative bus line of the second PV module.

4. The PV system of claim 3, further comprising a third PV module coupled to the second PV module in an electrically parallel configuration.

5. The PV system of claim 3, each PV module further comprising a carrier bus line operable to electrically couple to the respective vertical bus line, wherein the PV modules are adjacent to each other and are arranged horizontally, with at least the carrier bus line of each PV module being collinear with the carrier bus lines of the adjacent PV modules.

6. The PV system of claim 5, wherein the first and second PV module form a first electrically parallel subgroup, the PV system further comprising a second electrically parallel subgroup coupled to the first parallel subgroup having a third and fourth PV module inverted with respect to the first electrically parallel subgroup, and each of the bus lines of the third PV module are coupled to the corresponding bus line of the fourth PV module.

7. The PV system of claim 6, wherein the first electrically parallel subgroup is coupled to the second electrically parallel subgroup in series, such that the carrier bus line of the third PV module is coupled to the carrier bus line of the second PV module, the positive bus line of the third PV module is coupled to the negative bus line of the second PV module, and the positive and carrier bus lines of the second PV module are electrically coupled via the vertical bus line of the second PV module.

8. The system of claim 2, each PV module further comprising a carrier bus line operable to electrically couple to the respective vertical bus line, wherein the first and second PV modules are inverted with respect to each other and coupled in an electrically series configuration, such that the negative bus line of the first PV module is coupled to the positive bus line of the second PV module and the carrier bus line of the first PV module is coupled to the carrier bus line of the second PV module.

9. The PV system of claim 8, wherein a third PV module is coupled to the second PV module in series and the positive and carrier bus lines of the first PV module are electrically coupled via the vertical bus line of the first PV module, such that the first, second, and third PV modules are coupled together in series.

10. The PV system of claim 8, wherein the first and second PV module form a first series subgroup, the PV system furthering comprising a second series subgroup electrically coupled to the first series subgroup and includes a third and fourth PV module oriented and electrically together in a manner similar to the first series subgroup.

11. The PV system of claim 10, wherein the second series subgroup is coupled to the first series subgroup in an electrically parallel configuration, such that the carrier bus line of the second PV module coupled to the carrier bus of the third PV module, a grounding connector is coupled to the negative bus lines of the second and fourth PV modules, and the vertical bus line electrically couples the positive and carrier bus lines each of the first and third PV modules.

12. The PV system of claim 2, wherein the first and second PV modules are arranged vertically, such that the vertical bus lines of the first and second PV modules collinear, and the first and second PV modules are electrically coupled in series such that the negative bus line of the first PV module is electrically coupled to the positive bus line of the second PV module.

13. The PV system of claim 2, wherein the first and second PV modules are arranged vertically, such that the vertical bus lines of the first and second PV modules are collinear, and the first and second PV modules are electrically coupled in parallel such that the negative bus lines of the first and second PV modules are electrically coupled to grounding connectors, the vertical and positive bus lines of the first and second PV modules are electrically coupled together.

14. A photovoltaic (PV) system comprising one or more PV modules, the photovoltaic system further comprising:
a rack having a first side and a second side opposing the first side;
a PV array having two or more PV modules coupled together based on orientation of the two or more PV modules, each PV module comprising:
a PV layer having a first side and a second side opposite the first side; and
a conductive layer coupled to the second side of the PV layer, the conductive layer further comprising:
a positive bus line;
a carrier bus line;
a negative bus line, wherein the positive, carrier, and negative bus lines extend in a first direction; and
a vertical bus line that extends substantially orthogonally to the first direction, wherein the vertical bus line operable to electrically couple to the positive, carrier, and negative bus lines;
one or more bridging connectors operable to selectively electrically couple a given bus line of a first PV module with another bus line of the second PV module depending on a conductive character of a user-selectable fastener.

15. The PV system of claim 14, wherein the rack further comprises a vertical support housing a conductive element to provide a common ground, and the one or more bridging connectors are operable to mechanically and electrically couple the given bus line and the another bus line to the common ground.

16. The PV system of claim 15, the one or more bridging connectors further comprising:
a conductive substrate for carrying current between the given bus line and the another bus line;
one or more through holes that penetrate the conductive substrate;
one or more fasteners corresponding to the one or more through holes to mechanically fasten the respective bridging connector to the vertical support of the rack, wherein the one or more fasteners provide a conducting surface to electrically couple with the conductive substrate and electrically couple the given bus line to the other bus line and/or the common ground.

17. The PV system of claim 16, wherein one or more of the fasteners provides an insulating surface to one or more of the corresponding through holes to electrically decouple the given bus line from the common ground and/or the another bus line, with the first and second PV modules coupled in series or parallel based on orientation of the modules and surfaces provided by the one or more fasteners.

18. A connector for mechanically and electrically coupling two or more photovoltaic (PV) modules of a PV system, the connector comprising:
a first end for receiving a given bus line of a first PV module;
a second end for receiving another bus line of a second PV module;
a substrate that is conductive and operable to electrically couple the given bus line to the another bus line;
one or more through holes that extend through the respective connector and the substrate, and are configured to receive a fastener.

19. The connector of claim 18, wherein the one or more through holes receives a fastener for mechanically coupling the two or more PV modules, the fastener selectively providing a conductive surface to the one or more through holes to electrically couple the substrate and one of the given bus line or the another bus line.

20. The connector of claim 19, wherein the one or more through holes are a first through hole and the fastener is a first fastener that electrically couples the substrate and the given bus line, the connector further comprising a second through hole configured to receive a second fastener having a conductive surface for electrically coupling the substrate to a common ground via a conductive element of the PV system.
